(19) United States
(12) Patent Application Publication
(10) Pub. No.: US 2010/0161361 A1
(43) Pub. Date: Jun. 24, 2010

(54) PERFORMING ENTERPRISE PLANNING AND ECONOMICS ANALYSIS FOR RESERVOIR-RELATED SERVICES

(75) Inventors: Carl Francis Spears, Calgary (CA); Irving R. Lynch, Calgary (CA); Tao Ai, Calgary (CA); Michael John Back, Calgary (CA)

Correspondence Address: SCHLUMBERGER INFORMATION SOLUTIONS, 5599 SAN FELIPE, SUITE 1700, HOUSTON, TX, 77056-2722, US

(73) Assignee: Schlumberger Technology Corporation, Houston, TX (US)

(21) Appl. No.: 12/372,971

(22) Filed: Feb. 18, 2009

Related U.S. Application Data
(60) Provisional application No. 61/140,316, filed on Dec. 23, 2008.

(51) Int. Cl. G06Q 10/00; G06F 17/30; G06F 9/46

(52) U.S. Cl. 705/7; 718/107; 707/E17.014; 707/E17.125

(57) ABSTRACT

To perform economics management, data relating to reservoir-related services is received from a plurality of data sources. The received data is mapped into a cube-based data structure. In response to a query, data is retrieved from the cube-based data structure.

### TECHNICAL FIELD

The invention relates generally to performing enterprise planning and economics analysis for reservoir development and/or other services.

### BACKGROUND

Enterprise planning and economics analysis are important functions for enterprises involved in services related to hydrocarbon reservoirs (where services relating to hydrocarbon reservoirs includes exploration, drilling, completion, production, storage of hydrocarbons, distribution, marketing and sales of hydrocarbons, and/or other tasks related to reservoirs). Collectively, enterprise planning and economics analysis can be referred to as “economics management.” Examples of economics management tasks include profitability analysis, production forecasts, project analysis, cash flow analysis, determining finding and development costs, and others.

Traditionally, data associated with economics management tasks may be stored in one or more relational databases that store data in relations (or tables), or in other types of data stores. Conventional tools used for economics management that employ relational databases or other types of data stores may not offer the level of flexibility and analysis capabilities desired by users. Also, conventional tools may not offer enhanced reporting and visualization capabilities.

### SUMMARY

In general, according to an embodiment, a method of performing economics management for reservoir-related services includes receiving data relating to reservoir-related services from a plurality of sources, and mapping the received data into a cube-based data structure that enables more flexible and efficient data analysis and/or visualization.

Other or alternative features will become apparent from the following description, from the drawings, and from the claims.

### BRIEF DESCRIPTION OF THE DRAWINGS

FIG. 1 is a block diagram of an exemplary system incorporating an embodiment of the invention.

FIG. 2 illustrates a workflow that can be generated using the system of FIG. 1, in accordance with an embodiment.

FIG. 3 is a flow diagram of a process of performing economics management for reservoir-related services, according to an embodiment.

### DETAILED DESCRIPTION

An economics management tool according to some embodiments is provided to perform economics management, which includes enterprise planning and economics analysis, based on data that is stored in a cube-based data structure (e.g., a cube-based data warehouse). To enhance efficiency, data from a variety of sources having different formats can be mapped into the cube-based data structure. A cube-based data structure has multiple dimensions (three or more dimensions). In some embodiments, the cube-based data structure is an OLAP (online analytical processing) cube data structure. OLAP defines a technique to quickly answer multi-dimensional analytical queries, such as queries relating to business reporting, management reporting, financial reporting, economic analysis, and so forth. An OLAP cube is a data structure that allows fast analysis of data. The cube includes numeric facts called measures which are categorized by dimensions. The cube metadata may be created from a star schema or snowflake schema of tables in a relational database. Measures are derived from the records in the fact table and dimensions are derived from the dimension tables.

In accordance with some embodiments, the economics management tool is used by an enterprise (e.g., company, educational organization, government agency, etc.) involved in services related to reservoirs that contain hydrocarbons or other types of fluids (“reservoir-related services”). Reservoir-related services include any one or more of the following: exploration, drilling, infrastructure building at well sites, well completion, hydrocarbon production, storage of hydrocarbons, distribution, marketing and sales of hydrocarbons, and others.

Within an enterprise, there can be many sources of data, and such data may have varying formats. Moreover, some sources of data may be external to the enterprise. In accordance with some embodiments, the economics management tool is able to synchronize data of varying formats from different sources into a standard format, such that the data according to the standard format can be mapped into the cube-based data warehouse. Once data is stored in the cube-based data warehouse, OLAP queries can be submitted to allow for flexible analysis of the data contained in the cube-based data warehouse. Moreover, the economics management tool provides enhanced reporting and visualization of the data contained in the cube-based data warehouse.

In addition, the economics management tool according to some embodiments allows economic workflows to be generated by users. An economic workflow includes a number of steps to perform some particular task desired by a user, such as to perform analysis of one or more projects of the enterprise, to determine a current health of an enterprise's portfolio of well sites, to analyze whether or not the enterprise is meeting production targets, to perform forecasts, to perform profitability analysis, to determine hydrocarbon reserves maintained by the enterprise, and so forth.

The economics management tool can be separated into client and server components. The client component of the economics management tool is a desktop or web component that can be loaded at one or more client computers. A user at the client computer can invoke the client component of the economics management tool to perform various functions, including generation of economic workflows and to view results produced by a server component of the economics management tool.

The server component of the economics management tool is executed on one or more server computers. The server component of the economics management tool is able to receive economic workflows from one or more client computers, and to perform tasks specified by such economic workflows. For example, an economic workflow can specify that data from multiple sources are to be received and stored in a cube-based data warehouse. This economic workflow can also specify calculations to be performed on the received data.

According to another aspect of some embodiments of the invention, the economics management tool includes a calculation engine that can perform more efficient and faster calculations of results based on data contained in the cube-based data warehouse. The calculation engine is able to perform calculations in parallel on multiple processors that are located at multiple machines. In some implementations, the machines are connected to a network. The calculation engine can search for machines on which components of the economics management tool are loaded to perform the calculations.

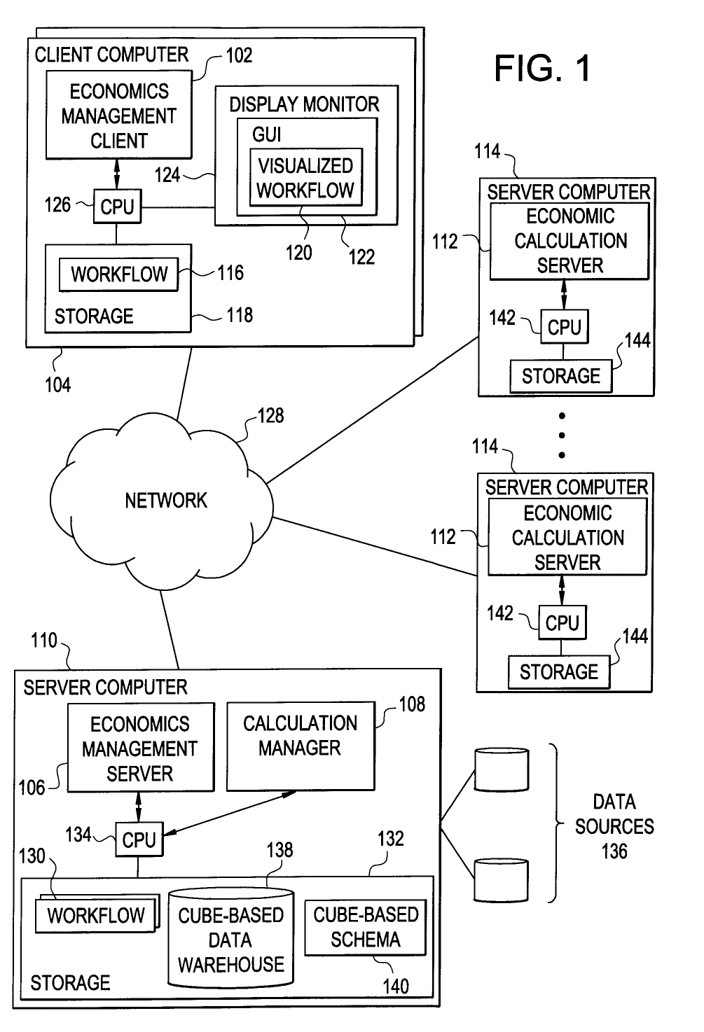

FIG. 1 illustrates an exemplary system that includes an economics management tool according to an embodiment. The economics management tool includes software modules deployed on multiple machines. The software modules include economics management clients 102 deployed on corresponding client computers 104, an economics management server 106 and calculation manager 108 deployed on a server computer 110, and economic calculation servers 112 deployed on corresponding server computers 114. The economics management servers 112 and calculation manager 108 together form the calculation engine of the economics management tool, where the calculation engine is useable to perform calculations requested in economic workflows received from client computers 104.

In other implementations, instead of providing economic calculation servers 112 on server computers 114 that are separate from the server computer 110, an economic calculation server 112 can be provided in the server computer 110. By distributing economic calculation servers 112 across multiple server computers 114 according to some embodiments, however, faster calculations of data can be performed by the economics management tool.

The various software modules of the economics management tool, including the economics management client 102, economics management server 106, calculation manager 108, and economic calculation server 112, are executable on one or more corresponding central processing units (CPUs) in each of respective machines, including CPU(s) 126 in the client computer 104, CPU(s) 134 in the server computer 110, and CPUs 142 in the server computers 114. Each CPU (126, 134, 142) is connected to a respective storage 118, 132, and 144 in the respective machine.

The economics management client 102 executed in a client computer 104 is accessible by a user at the client computer 104. The user can use the economics management client 102 to generate a workflow 116 that specifies tasks to be performed by the server side of the economics management tool, including the economics management server 106, calculation manager 108, and economic calculation servers 112. As depicted in FIG. 1, the economic workflow 116 is stored in the storage 118 of the client computer 104.

When generating the workflow 116, the economics management client 102 can present a visualized workflow 120 in a graphical user interface (GUI) screen that is displayed in a display monitor 124 of the client computer 104. The visualized workflow 120 allows a user to specify tasks in the form of icons (or other display elements) that represent respective tasks that are part of the economic workflow 116.

The client computers 104 are connected over a network 128 (such as a network to communicate data packets) to the server computer 110. Workflows 116 generated by the economics management clients 102 in the client computers 104 can be communicated over the network 128 to the server computer 110. These workflows received from the client computers 104 are stored as workflows 130 in the storage 132 of the server computer 110.

The economics management server 106 controls when one or more of the economic workflows 130 are executed by the server computer 110. In one example, an exemplary economic workflow 130 can specify that data relating to reservoir management is to be received from multiple data sources 136. These data sources 136 can be data sources within an enterprise, or these data sources can include data sources outside the enterprise. The data stored in the various data sources 136 can have varying formats, including data in relational databases and data in other formats.

Data from the data sources 136 is received by the server computer 110 and subjected to further processing as specified in the exemplary workflow 130. The exemplary workflow 130 can specify that synchronization of the data according to various formats from the data sources 136 into a standard format is to be performed. The exemplary workflow 130 can also cause the synchronized data to be stored into a cube-based data warehouse 138 that is stored in the storage 132 of the server computer 110. A schema 140 that defines the structure of the data stored in the cube-based data warehouse 138 can also be stored in the storage 132. The schema 140 can define the various dimensions of the cube-based data warehouse 138.

Examples of the dimensions of the cube-based data warehouse 138 include at least some of the following: (1) economic results (relating to data produced by economic calculations performed by the economic calculation servers 112); (2) reserves results (relating to data produced by calculations for determining hydrocarbon reserves volume); (3) production forecasts (relating to data regarding forecasts produced by the economic calculation servers 112, such as forecasts of profitability, forecasts of production volume, etc.); (4) key performance indicators (KPI) (which are measures of various performance aspects relating to development of a reservoir); (5) price outcomes (relating to actual or expected prices of hydrocarbons); (6) project outcomes (relating to data regarding various possible scenarios for economic and/or reserve analyses); (7) time; (8) attributes (relating to attributes regarding reserves and economic data); (9) versions (which specify the version of the economics management tool); (10) currencies (which indicate the currency of the corresponding economic data); (11) economic and financial results, (12) and others. The list of dimensions provided above is provided for purposes of example, as other implementations can employ other types of dimensions.

The calculation manager 108 of the server computer 110 is responsible for farming calculations specified by an economic workflow 130 to one or more economic calculation servers 112. To enhance the speed of calculations to be performed, the calculation manager 108 can farm out calculations specified by an economic workflow onto multiple server computers 114, such that the calculations are performed in parallel by multiple CPUs 142. In some embodiments, the calculation manager 108 is able to search the network 128 to find server computers 114 on which the economic calculation server 112 has been loaded.

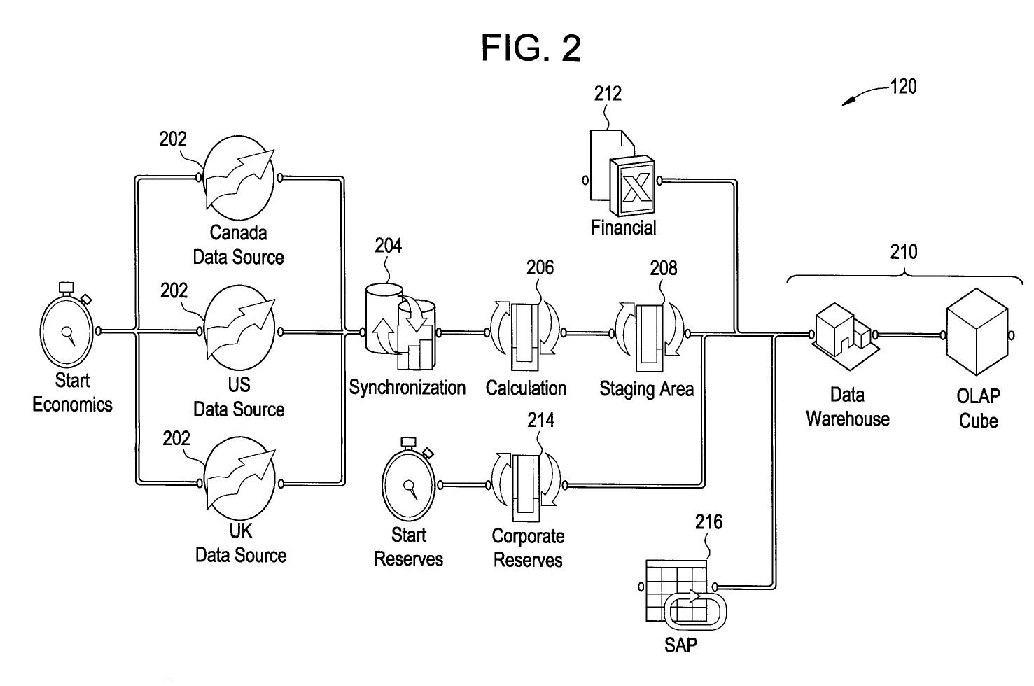

FIG. 2 illustrates a visualized workflow (such as visualized workflow 120 in FIG. 1) that can be created by the economics management client 102 based on interactive usage of the economics management client 102 by a user. In other words, the visualized workflow 120 depicted in FIG. 2 can be interactively created by a user using the economics management client 102 at a client computer 104.

In the visualized workflow 120, data source icons 202 represent sources of data that are to be received by the represented economic workflow. The data source icons 202 can represent the data sources 136 depicted in FIG. 1, for example.

A synchronization icon 204 represents the task of synchronizing the data received from the data sources represented by the data source icons 202. The data from the different data sources may have different formats. The synchronization task 204 causes the different formats of the data sources to be synchronized to a standard format.

Next, a calculation icon 206 represents calculations that are to be performed on the synchronized data. The calculation icon 206 can cause the calculation manager 108 in the server computer 110 (FIG. 1) to farm out the calculations to one or multiple economic calculation servers 112 running on respective server computers 114.

The results of the calculations represented by the calculation icon 206 are stored in a staging area represented by a staging area icon 208. The staging area can be temporary storage, such as memory of the server computer 110. Alternatively, the staging area 208 can be provided in persistent storage such as storage 132 in the server computer 110.

Data from the staging area 208 can be stored in the cube-based data warehouse, as represented by icons 210. The cube-based data warehouse represented by icons 210 can also receive data from data sources represented by icons 212, 214, and 216. The data source icon 212 can represent a financial data source, the data source icon 214 can represent a reserves data source (which indicates the amount of remaining hydrocarbon reserves, for example), and the data source icon 216 can represent a SAP database.

The visualized workflow 120 that is created by the economics management client 102 can then be stored as workflow 116 in the storage 118 of the client computer 104 (FIG. 1). The workflow 116 can then be communicated from the client computer 104 to the server computer 110 for execution.

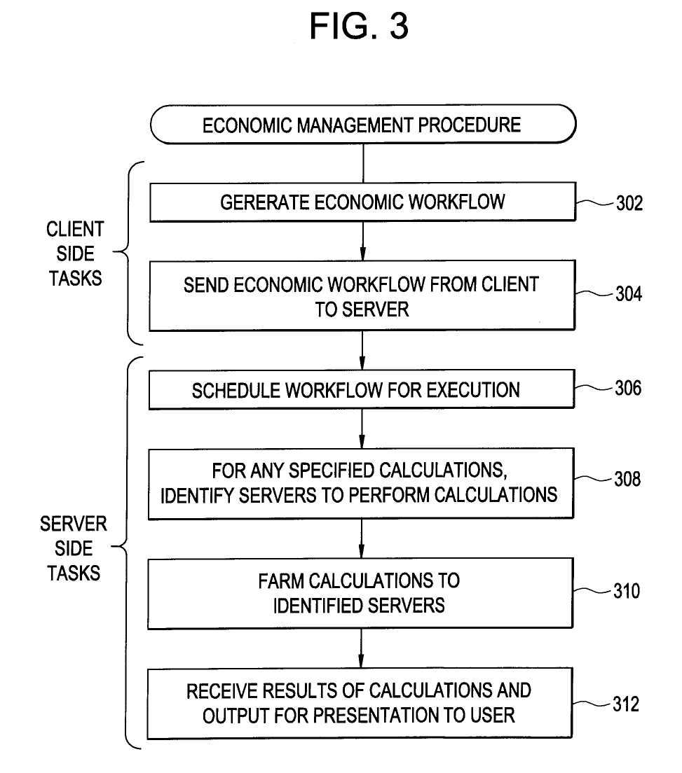

FIG. 3 is a flow diagram of a process performed by the economics management tool according to some embodiments. Note that some of the tasks may be performed at the client side (client side tasks performed by a client computer 104 in FIG. 1) and some of the tasks may be performed at the server side (server side tasks preformed at server computers 110 and/or 114 in FIG. 1).

An economic workflow can be generated (at 302), such as based on interactive use by a user of the economics management client 102. The generated economic workflow is sent (at 304) from a client computer 104 to the server computer 110.

At the server computer 110, an economic workflow is scheduled (at 306) for execution. For any specified calculations, the calculation manager 108 in the server computer 110 can identify (at 308) economic calculation servers 112 to perform the calculations. The calculation manager 108 can, for example, search the network 128 to find server computers 114 on which economic calculation servers 112 are loaded, and the calculation manager 108 can select all or a subset of the economic calculation servers 112 to perform the specified calculations.

The calculations are then farmed (at 310) to the identified servers. The results of the calculations are then received (at 312) by the economics management server 106. The results of the calculations can be output for presentation to a user, such as by communication over the network 128 to a client computer 104, where the results can be visualized in the GUI 122 in the display monitor 124.

Instructions of software described above (including the software modules of the economics management tool shown in of FIG. 1) are loaded for execution on a processor (such as one or more CPUs 126, 134, and 142 in FIG. 1). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method executed by at least one computer of performing economics management for reservoir-related services, comprising:
receiving data relating to reservoir-related services from a plurality of data sources;
mapping the received data into a cube-based data structure; and
in response to a query, retrieving data from the cube-based data structure.

2. The method of claim 1, wherein the reservoir-related services include any one or more of the following: exploration, drilling, infrastructure building at well sites, well completion, hydrocarbon production, storage of hydrocarbons, distribution, and marketing and sales of hydrocarbons.

3. The method of claim 1, wherein mapping the received data into the cube-based data structure comprises mapping the received data into an online analytic processing (OLAP) cube data structure.

4. The method of claim 3, wherein the query comprises an OLAP query, the method further comprising processing the data retrieved from the cube-based data structure in response to the OLAP query.

5. The method of claim 1, wherein the cube-based data structure has dimensions selected from at least some of the following: economic results, reserves results, production forecasts, key performance indicators, price outcomes, project outcomes, time, attributes, versions, currency, and economic and financial results.

6. The method of claim 1, further comprising:
generating a workflow relating to the economics management for reservoir-related services.

7. The method of claim 6, wherein generating the workflow comprises generating the workflow to receive the data from the plurality of sources and to map the received data into the cube-based data structure, wherein the cube-based data structure is a cube-based data warehouse.

8. The method of claim 7, wherein the generated workflow further comprises a step to synchronize different formats of the received data from the plurality of sources to a standard format.

9. The method of claim 8, wherein the generated workflow further comprises a step of performing calculations on the received data after synchronizing the received data.

10. The method of claim 1, further comprising:
causing calculations performed on the received data to be run on multiple processors.

11. The method of claim 10, wherein the multiple processors include processors in multiple machines connected to a network.

12. The method of claim 11, further comprising:
searching for machines on which a particular software has been loaded to perform the calculations.

13. A computer system comprising:
at least one storage to store a workflow specifying tasks to be performed relating to management of a reservoir containing fluids; and
at least one processor to:
execute the workflow that specifies mapping of data received from multiple data sources into a cube-based data structure.

14. The computer system of claim 13, wherein the workflow further specifies synchronization of different formats of the received data into a standard format.

15. The computer system of claim 13, wherein the at least one processor is to further:
receive an online analytical processing (OLAP) query, and in response to the query, access the cube-based data structure.

16. The computer system of claim 13, wherein the at least one processor is to receive the workflow from a client computer.

17. The computer system of claim 13, wherein the workflow further specifies calculations to be performed on the received data, and wherein the at least one processor is to select multiple machines to perform the calculations.

18. The computer system of claim 17, wherein the at least one processor is to select the multiple machines to perform the calculations by identifying the machines that contain a component of an economics management tool.

19. An article comprising at least one computer-readable storage medium containing instructions that when executed cause at least one computer to:
execute a client component of an economics management tool;
present, by the client component of the economics management tool, a graphical user interface; and
in response to interactive input from a user, create a workflow relating to economics management relating to reservoir-related services, wherein the workflow specifies mapping of data into a cube-based data structure.

20. The article of claim 19, wherein the instructions when executed cause the at least one computer to further send the workflow to a server computer for execution on the server computer.

21. The article of claim 19, wherein the workflow specifies calculations to be performed on the data received from data sources, and wherein the calculations are to be calculated on multiple processors.

22. The article of claim 19, wherein the cube-based data structure is an online analytical processing (OLAP) cube data structure.
